(19) United States
(12) Patent Application Publication
(10) Pub. No.: US 2010/0254500 A1
(43) Pub. Date: Oct. 7, 2010

(54) Acoustic inertial confinement nuclear fusion device

(76) Inventor: Rusi P. Taleyarkhan, Lafayette, IN (US)

Correspondence Address: DUANE MORRIS LLP - Chicago;IP DEPARTMENT, 190 South LaSalle Street, Suite 3700, CHICAGO, IL, 60603-3433, US

(21) Appl. No.: 11/653,791

(22) Filed: Jan. 16, 2007

Related U.S. Application Data
(60) Provisional application No. 60/759,454, filed on Jan. 17, 2006.

(51) Int. Cl. G21B 1/03; G21B 1/11

(52) U.S. Cl. 376/102; 376/114

(57) ABSTRACT

An acoustic inertial confinement nuclear fusion device is disclosed. The device includes an enclosure that holds a fluid with dissolved alpha emitters. A generator is coupled to the enclosure, and the generator is configured to harmonically drive the fluid in the enclosure to induce an acoustic standing wave in the fluid. The dissolved alpha emitters nucleate bubble clusters in the fluid as the fluid is driven by the generator. Neutrons, tritium and/or gamma rays, are emitted from the fluid, without or with an external source of neutrons.

### PRIORITY CLAIM

This application claims the benefit of priority of U.S. Provisional Application Ser. No. 60/759,454, “Acoustic Inertial Confinement Nuclear Fusion Device,” filed Jan. 17, 2006, the contents of which are hereby incorporated by reference.

### BACKGROUND

1. Technical Field

This invention relates to inertial confinement nuclear devices. In particular, the invention relates to an acoustic inertial confinement nuclear device.

2. Related Art

It is well known that the intense implosive collapse of bubbles, including acoustic cavitation bubbles, can lead to extremely high compressions and temperatures, and to the generation of light flashes attributed to sonoluminescence (SL). In addition, for suitable conditions and materials, nuclear emissions may also occur. The modeling and analyses of the basic physical phenomena associated with such a process have been discussed in detail elsewhere. Essentially, the process starts with bubble implosion, during the compression phase of the impressed acoustic pressure field, when the gas/vapor interfacial Mach number is much less than unity. As the interfacial Mach number approaches unity a compression shock wave is formed in the gas/vapor mixture and this shock wave moves toward the center of the bubble and, in doing so, intensifies. As the shock wave bounces off at the center of the bubble it highly compresses and heats a small core region near the center of the bubble. At this point there is a SL light pulse, and if there is a suitable (e.g., deuterated) fluid and the bubble temperatures, density and duration are sufficient, there may also be conditions suitable for nuclear emissions (i.e., thermonuclear D-D fusion). The light and nuclear emissions and the pressurization process continue until a short time later when the interface comes to rest. Thereafter, there occurs an onset of bubble expansion during the rarefaction phase of the impressed acoustic pressure field, and a rarefying shock wave is formed in the fluid surrounding the bubble during the bubble growth process.

### SUMMARY

An acoustic inertial confinement nuclear fusion device is disclosed. The device includes an enclosure that holds a fluid with dissolved alpha emitters. A generator is coupled to the enclosure, and the generator configured to harmonically drive the fluid in the enclosure to induce an acoustic standing wave in the fluid. The dissolved alpha emitters nucleate bubble clusters in the fluid as the fluid is driven by the generator, and neutrons, tritium, or gamma rays, or both are emitted from the fluid, without an external source of neutrons.

A method of generating radiation from an acoustic inertial confinement nuclear fusion device is also disclosed. The nuclear fusion device includes an enclosure that holds a fluid with dissolved alpha emitters and a generator coupled to the enclosure. The fluid in the enclosure is harmonically driven to induce an acoustic standing wave in the fluid. The dissolved alpha emitters nucleate bubble clusters in the fluid as the fluid is placed under tension metastably when acoustically driven by the generator, and radiation is generated and emitted from the fluid.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views. In this document UN stands for Uranyl Nitrate, TN stands for Thorium Nitrate.

FIG. 1 is a schematic block diagram of an acoustic inertial confinement nuclear device.

FIG. 2 is a process that generates radiation from the acoustic inertial confinement nuclear device of FIG. 1.

FIG. 3 is a schematic block diagram of a nuclear device and detection system.

FIG. 4 illustrates example results from an operation of the nuclear device and detection system of FIG. 3.

FIGS. 5a-b illustrate neutron-gamma spectra with Lil detector for self-nucleated D₂O—UN solution.

FIG. 6 illustrates pulse height spectra for a C₆H₆—C₂Cl₄—C₃H₆O—UN solution.

FIG. 7 illustrates pulse height spectra for a C₆D₆—C₂Cl₄—C₃D₆O—UN solution.

FIG. 8 illustrates change in counts from pulse height spectra in FIGS. 7 and 8 for C₆H₆—C₂Cl₄—C₃H₆O—UN and C₆D₆—C₂Cl₄—C₃D₆O—UN solutions with self nucleation.

### DETAILED DESCRIPTION OF THE INVENTION

An acoustic inertial confinement nuclear device generates ultrahigh compression effects and temperatures in vapor bubbles nucleated in highly tensioned fluids by means of dissolved alpha emitters. The use of alpha emitters suitably chosen in conjunction with the working fluids permits the development of a self-perpetuating (nucleating) nuclear reactor without the need for an external nucleating source. Once nucleated the bubble radius increases from an initial radius (Ro) of tens of nanometers to a maximum radius (Rm) in the millimeter range. The fluid's kinetic energy, which is accumulated during the implosion stage, and is subsequently converted to internal energy in and around the bubble, is given by E=pₘRₘ³ where pₘ is the amplitude of the acoustic pressure. In typical sonofusion experiments, pₘ=15 bar, Rₘ=500 to 800 μm which leads 10⁴ to 10⁵ times more fluid phase kinetic energy, E, than in typical Single Bubble Sonoluminescence (SBSL) experiments (i.e., where: pm=1.5 bar, Rm=50 μm). Such an approach, with its vastly increased energy concentration potential during implosions, gives rise to much higher peak temperatures and densities within the imploding bubbles, possibly leading to D-D fusion and detectable levels of nuclear particle emissions in suitable deuterated fluids.

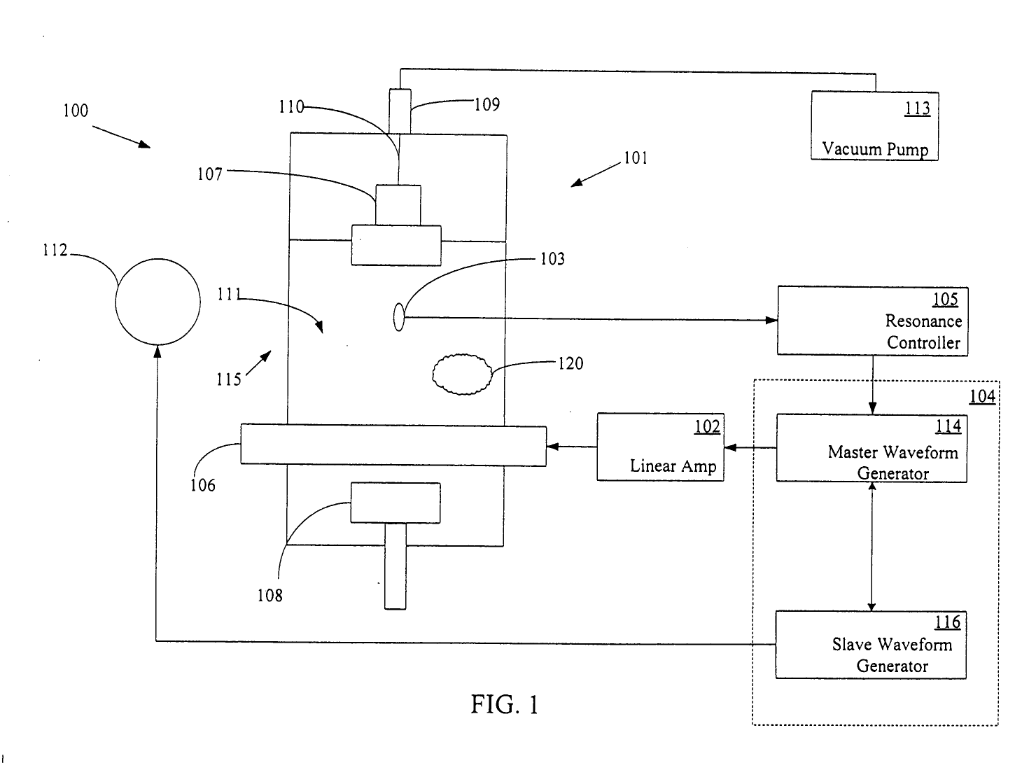

FIG. 1 illustrates an example acoustic inertial confinement nuclear device 100. The nuclear device 100 may function as a stand-alone thermonuclear acoustic fusion reactor (i.e., without the need for an external neutron sources). The nuclear device 100 includes an enclosure 115 formed by an interior of a reactor cell 101, in which a fluid 111 may be located. A solution of dissolved alpha emitters 120, such as a solution of a deuterated solvent and a uranium salt or thorium salt, is dissolved in the fluid 111. The dissolved alpha emitters 120 generate bubbles by nucleation in the fluid 111 during operation of the nuclear device 100.

In a preferred embodiment, the nuclear device 100 includes an amplifier, such as linear amplifier 102 coupled with the test cell 101. The linear amplifier 102 may be implemented with a Model MPA-105 linear amplifier manufactured by PiezoSystems, Inc. Such a linear amplifier 102 provides sufficient power to the system at high frequency levels. Therefore, an oscillating power delivery device such as the PiezoSystems, Inc., Cambridge, Mass. amplifier model EPA-104, utilized for this study may be used.

Once bubbles are nucleated with the working fluid in the enclosure 115, the bubbles typically oscillate for over approximately 5 milliseconds (if the working fluid is based on combination of acetone and benzene in tetrachloroethylene and operating temperature is around 5° C.) before redissolving, during the course of which the bubbles need to be driven at high frequencies. The emission of sonoluminescence (SL) light during bubble implosions and the emission of neutrons from thermonuclear fusion are greatest “after” the first implosion. Before the first implosion, the enclosure 115 is driven in a resonant mode of approximately 20 kHz. After nucleation and the first implosive collapse, the reactor cell frequencies can increase dramatically (and may be detected from shock traces of a pill-hydrophone 103 attached to the test reactor walls). Low-frequency amplifier-drive systems degrade in performance during this crucial time period, whereas high-frequency capable amplifier drive systems have been found to assist thermonuclear fusion reactions in the nuclear device 100.

The nuclear device 100 also includes a programmable wave-form generator 104, such as an Agilent, Inc., Model 33120A which is coupled to the pill-microphone 103 attached to the reactor cell 101. The waveform generator 104 may include a master waveform generator 114 and a slave waveform generator 116. The slave waveform generator 116 may be used when a pulsed neutron generator 112 is used with the nuclear device 100.

An acoustic wave energy generator, such as piezoelectric driver 106 is operatively coupled to the reactor cell 101 and the enclosure 115. The piezoelectric driver 106 drives the fluid 111 in the enclosure 115, such as by harmonically driving or aperiodically driving the fluid 111. The piezoelectric driver 106 induces an acoustic standing wave in the fluid 111 of the enclosure 115. The acoustic standing wave has a pressure antinode of maximum amplitude of about 3 to 5 bar to permit initiation of nucleation (e.g., when the organic fluid mixture contains acetone, benzene and tetrachloroethylene), and preferably a maximum amplitude of about 15 bar to initiate significant (10⁴ n−T/s) D-D fusion output, and higher as desired to derive greater D-D fusion output all the while maintaining spherical bubble cluster implosions.

The microphone signals from the microphone 103 are transmitted to a control system, such as a resonance controller 105, which monitors the filtered noise signals in the microphone 103 and which then sends a signal to the wave form generator 104. The reactor cell 101 is maintained in a resonance mode so as to maximize the microphone baseline as well as noise signals (which come into being when bubbles have been nucleated).

The reactor cell 101 may be fabricated either with all-Pyrex glass or by using a combination of quartz and Pyrex glass versus the use of an all-Pyrex system. The material for the piezoelectric driver 106 may be a lead-zirconatetitanate (PZT) material purchased from Channel Industries, Inc. (Navy Model 5800). The piezoelectric driver 106 may be oscillated in the radial mode (versus axial). To center the piezoelectric driver 106 around the reactor cell 101, three electric leads may be soldered on the inside (positive) surface of the piezoelectric driver 106. Another benefit of such a feature is that one can drive the piezoelectric driver 106 more uniformly in parallel or in series. Another benefit is that if one of the electrical leads get broken, the other remaining leads are available to be utilized without having to dismantle the setup. The gap between the inside of the piezoelectric driver 106 and the quartz walls is then filled with conventional 30-minute two-part epoxy. The outside surface of the PZT ring can employ several leads for convenience. If the lead gets broken, it can readily be re-soldered.

The reactor cell 101 should preferably encompass two diametrically symmetrically positioned pill-microphones 103 (such as from Channel Industries, Inc.—diameter˜0.25″). The microphone disks may be epoxied preferentially in the centerline of the reactor cell 101.

The reactor cell 101 may include top and bottom reflectors 107 and 108. The top reflector 107 and the bottom reflector 108 may be piston-shaped. The top reflector 107 and the bottom reflector 108 are not integral with the glass walls. The bottom piston is connected to the main test chamber using a suitable epoxy compound that is not attacked by the host fluid. RTV cement (model AZUL RTV 63 by Permetex, Inc., Great Plains Aircraft supply Co., Boys Town, Nebr.) may be used for different fluids in the reactor cell 101 (i.e., acetone, benzene, tetradecane, tetrachloroethylene, ethanol, methanol and water—all which may be used with and without the inclusion of alpha emitter salts such as uranyl nitrate, uranyl acetate, or thorium nitrate).

The top portion 109 of the reactor cell 101 is also made to be separate and such that it can be affixed to the vertical cylinder. The same RTV cement used for affixing the bottom reflector 108 can be used here, although any other type of epoxy not attacked by the working fluid can come in direct contact with the test fluid.

The top reflector 107 needs to be free-floating and hanging freely with a thin (preferably stainless steel) metal thread 110. The free-hanging top reflector 107 may enable resonance buildup to permit the top reflector 107 to self-align rather than be fixed. To avoid rattling of the top reflector 107 with the side walls, it is useful to provide a circular thin acrylic or other such disk atop the piston such that the top piston does not sway too far and impact the side walls. This circular disk has helped to avoid glass breakage upon repeated impact. This geometry also minimizes spraying fluid from entering the top reflector 107. The top portion 109 of the reflector needs to preferably be kept at the same pressure as the atmosphere portion of the test reactor cell 101 to avoid breakage from unequal pressures. However, it should not be allowed to fill up with the fluid 111. Therefore, the top vertical tube needs to be sealed with only a tiny (<0.5 mm) hole to permit pressure equalization. A vacuum pump 113 may be operatively coupled with the reactor cell 101 to evacuate the enclosure 115.

For the purpose of conducting self-nucleation experiments with dissolved alpha or fission product nucleating agents the following combinations (with hydrogen atoms replaced with deuterium—heavy hydrogen—in benzene, acetone, and water) may be used:

a) Benzene+C₂Cl₄+Acetone+Uranyl Nitrate Hexahydrate (UN)

b) C₂Cl₄+Acetone+UN

c) Acetone+UN or TN (Thorium Nitrate)

d) Water+UN or TN

For experiments in which self-nucleation is not possible, or if increased control over timing and intensity is desired, external neutron source is needed. Examples of an external neutron source in isotope sources such as Pu—Be, Am—Be, Cf-252 that emits neutrons randomly in time. Accelerator-driven sources such as pulsed neutron generators 112 (PNGs) may also be used. Isotope sources can be used without need for co-ordination with the drive frequency or phase. If PNGs 112 are used, the neutron emission from the PNG burst should be timed to arrive when the fluid pressure field is negative (i.e., molecules are under tension to levels greater than that needed for nucleation to begin from neutrons). Fluids where self-nucleation is possible are the mixtures (a to d) identified above as well as fluids such as methanol, ethanol, benzene, acetone, trimethyl borate. It is also preferable to use deuterated tetradecane with acetone and UN/TN since this fluid embodies extremely low vapor pressure and has one of the highest molecular weights. Deuterated tetradecane also has much lower sonic velocity and therefore very readily assists for shock wave generation and eventual supercompression. Benzene by itself is not a suitable candidate because the threshold for nucleation. Benzene by itself does not become a good choice since the threshold for nucleation with fast neutrons or alpha particles is very high in tension˜−13 bar versus˜−7 bar for acetone or C₂Cl₄. Therefore, mixing benzene in various proportions with C₂Cl₄ may be necessary if it needs to be used. Also, neither benzene nor C₂Cl₄ dissolves alpha emitters like UN or TN. However, acetone readily dissolves UN and TN and the mixture is readily possible to dissolve in benzene or C₂Cl₄.

A process for preparing the proportions for use in the test reactor cell 201 is described below. For item (a) above, first mix preferably up to 5 to 7 g of UN into 80 cc of acetone. Mix this solution with 500 cc of mixture composed of equal parts of C₂Cl₄ and benzene. This produces a batch of 580 cc of mixture that can be utilized as needed to fill up the test reactor. For the test cell 201 of FIG. 1, it was found that a fluid height of 9.5 cm above the bottom piston face was optimal to enable bubble cluster nucleation at the rate of 1 to 2 clusters per second.

Next, 3 g of either UN or TN may be added to 300 cc of water. Operation of the test reactor cell 201 using water may be conducted using the Pyrex type test reactor. A fluid height of about 3 cm above the bottom reflector may be optimal to enable bubble cluster nucleation at the rate of ˜5 clusters per second.

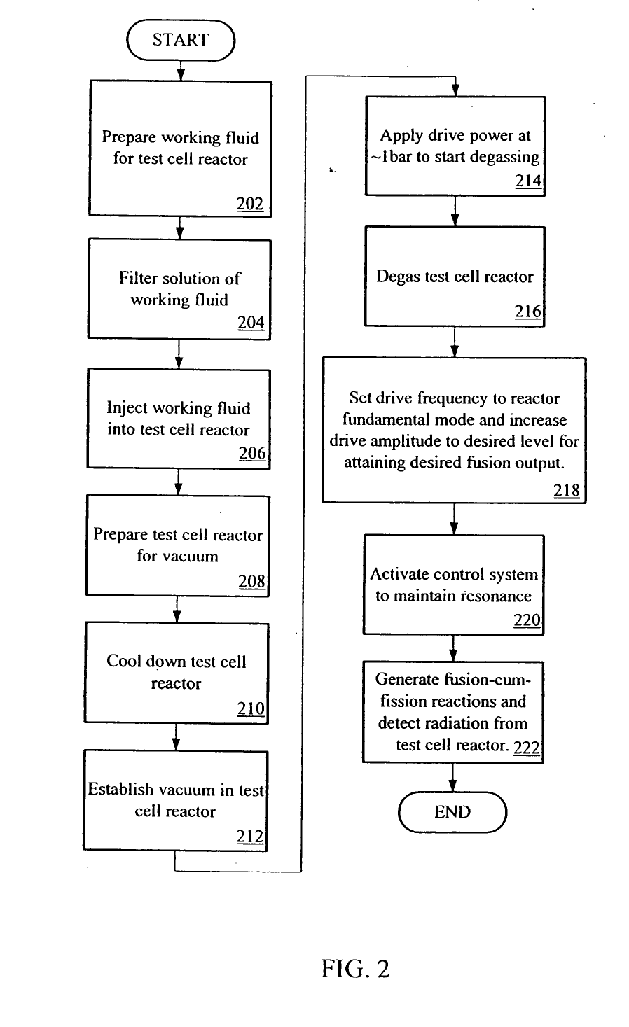

FIG. 2 illustrates a process to operate the nuclear fusion system 100. A working fluid 111 is prepared, at step 202, as described above. The mixture is filtered, at step 204, with a 0.5 micron filter and then through a filter, such as a coffee filter. The working fluid is injected, at step 206, to the desired height such that the top reflector's piston dips into the fluid by about 5-6 mm under room temperature conditions. The reactor cell 101 is prepared for vacuum, at step 208. Vacuum grease is applied to the outside of the top stem. Dow Corning Vacuum Grease #2021846-0702 may be used. A vacuum line is attached to the top of the reactor cell 101 so that the material does not get attacked by the vapors of the test fluids to the top. Rubber (red industrial variety) hose of 2 to 4 mm thick may be used. The vacuum line is connected to a vacuum pump. The side stem is connected to the bottom stem of the bottom reflector 108 in a similar fashion using vacuum grease.

The reactor cell 101 is introduced on to a stand in the air-cooled enclosure and allowed to cool down to about 5 C, at step 210. A vacuum is established in the test reactor cell 101 at step 212. Vacuum is pulled to approximately 20″ Hg as read on the dial of the vacuum pump.

At this point the drive power from the amplifier-generator system, such as the piezoelectric driver 106, is applied at ˜1 bar pressure, at step 214 (with about 1 V from the wave-form generator) at an oscillation frequency of about 16 kHz. This enables degassing to start and progress. A foamy fluid mass appears. The degree of vacuum indicated will drop and will need to be rectified as it drops by operating the pump.

Next, the drive frequency is set to a reactor fundamental mode and the drive amplitude is increased to a desired level for attaining desired fusion output, at step 216. Degassing is continued for at least approximately 60 minutes till the foamy fluid turns clear with individual bubbles appear getting nucleated. During this stage individual bubble nucleation will take place only if a dissolved alpha emitter is present in the fluid mixture, or if an external neutron source is present. Alternately, a pulsed laser beam can also be used but is not recommended. The process of degassing can be accelerated even if alpha emitters are included in the fluid by use of external neutron sources. If a PNG 112 is used, the neutrons from PNG 112 need to be introduced into the system to arrive when the fluid pressure is most negative. At first these bubble clusters will appear to be like comets or streamers.

The vacuum is set to about 25″ Hg, and the drive frequency of the piezoelectric driver 106 is set to the test reactor's fundamental resonance mode, at step 218. The piezoelectric driver 106 harmonically drives the fluid 111 in the reactor cell enclosure. Higher modes may also be utilized. Degassing continues until the comet-like structures turn into spherically-looking bubble clusters.

The control system 105 may be activated for maintaining resonance, at step 220. The reactor cell 101 generates fusion-cum-fission reactions and radiation, such as neutrons, gamma rays, or a combination thereof is detected using external detectors coupled with the nuclear fusion system 100, at step 222. Nuclear reactions products, such as tritium, may also be produced and detected.

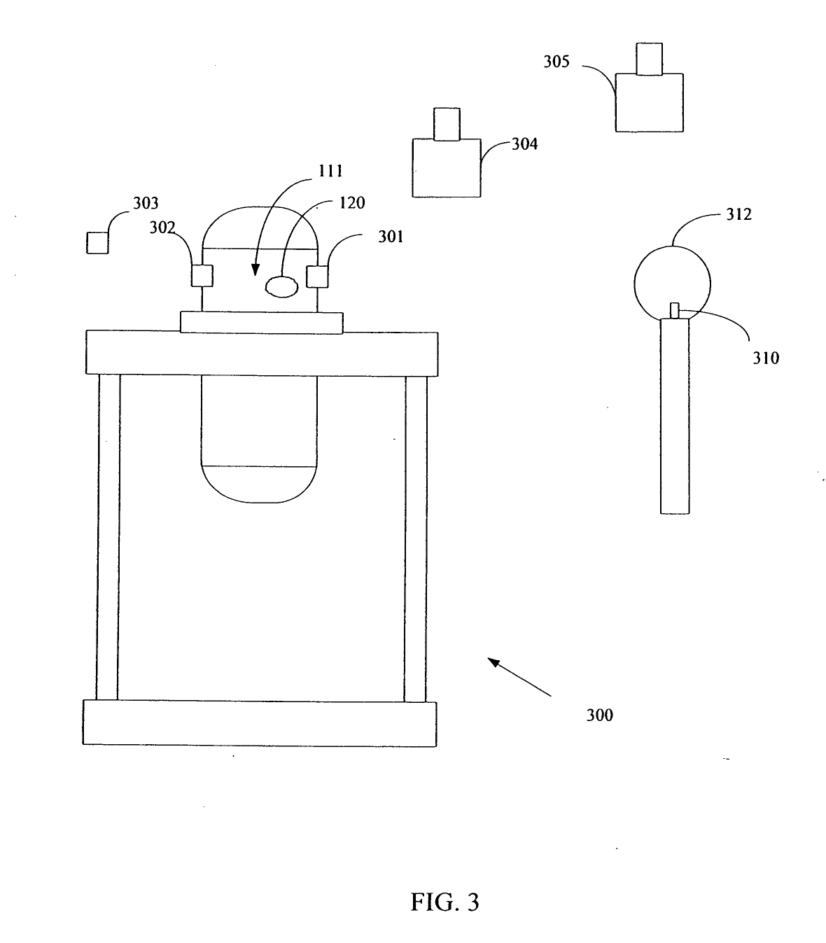

The reactor system 300 utilized for the present invention is shown in FIG. 3. For periodic (e.g., hour scale) monitoring and recording nuclear fusion output, the reactor cell 101 may further include 1 cm² (1 mm thick) neutron track detectors (301, 302 and 303) either coupled with the reactor cell 101 (neutron track detectors 301 and 302) or arranged proximate to the reactor cell 101 (neutron track detector 303). The nuclear fusion reactor system 300 may also include a gamma ray detector 304, and a neutron detector 305. The gamma ray detector 304 may be implemented as a Nal detector. The neutron detector 305 may be implemented as a fluid scintillation detector.

During operation, radiation emission results are obtained in cycles; first with cavitation turned on for 100 to 300 seconds and then cavitation was turned off for 100 to 300 seconds. The cycles were repeated systematically. Variation in the neutron emission (output for deuterated cases with cavitation on) for over 2 h or so of operation fluctuated modestly (within +/−20% of the mean), whereas, the background which was monitored continuously (i.e., in between every cavitation on runs) would remain well within 1 to 2 standard deviation of the background counts.

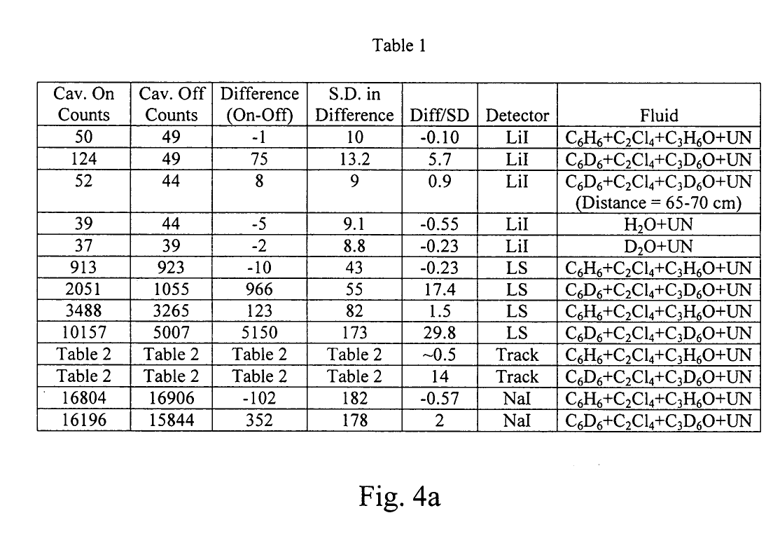

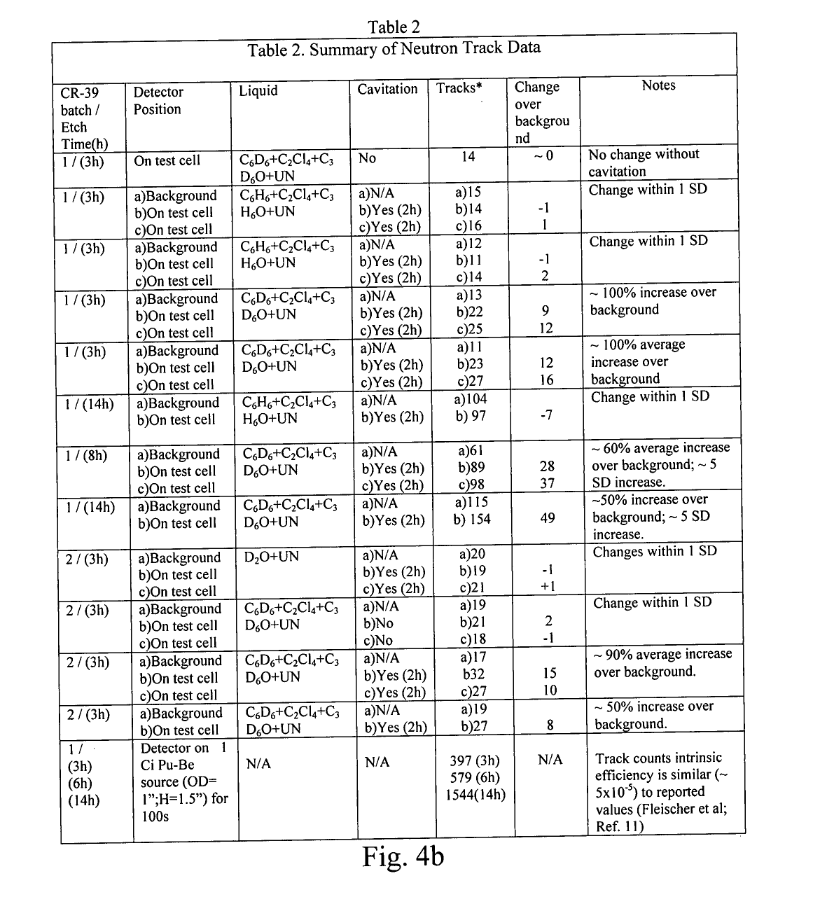

The experimental reactor system 300 included a Lil nuclear particle detector 310. The Lil nuclear particle detector 310 has a length of approximately 4.5 cm and a diameter of approximately 1.25 cm. The Lil nuclear particle detector 310 includes a 20 cm diameter paraffin ball moderator 312 over the Lil nuclear particle detector 310 to enhance thermal neutron fluxes since Lil has a high cross-section for absorption only for low-energy neutrons. The Lil nuclear particle detector 310 may be calibrated for efficiency of detection and also with distance using a NIST certified Pu—Be source (emitting ˜2×10⁶ n/s) as well as with 1 μCi Co-60 and Cs-137 gamma ray sources. Results from nuclear particle-nucleated cavitation tests shown in Table 1 of FIG. 4 were obtained with a Lil thermal neutron detector (TND) at an approximate distance of 30 cm from the test cell. Data were taken over an aggregate time of 7,200 s (i.e., 3,600 s with cavitation and 3,600 s with cavitation off) for each test fluid solution. Data presented represent a total of twenty-four (24) runs in 12 cycles (each cycle conducted over a span of 300 s first with cavitation on and then for 300 s with cavitation turned off). Operation with the control fluid mixture C₆H₆—C₂Cl₄—C₃H₆O—UN may not result in any statistically significant change in counts over background. In contrast, the results of operation with the deuterated mixture C₆D₆—C₂Cl₄—C₃D₆O—UN produces a statistically significant [˜6 standard deviation (SD)] emission, with ˜400% increases in neutron counts and ˜100% increases of gamma ray counts. As a cross-check, the distance of the detector from the test cell was roughly doubled from a nominal ˜30-35 cm to about 65-70 cm and the operation was repeated.

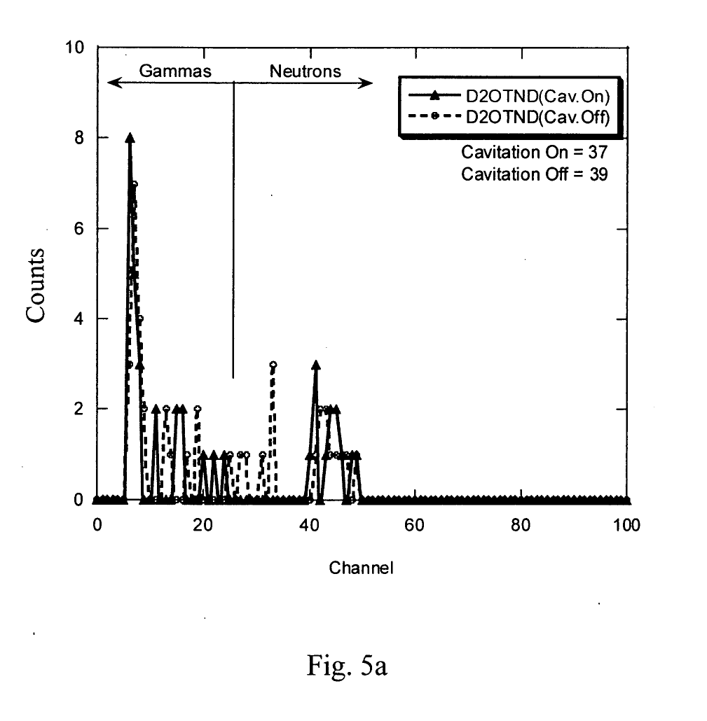

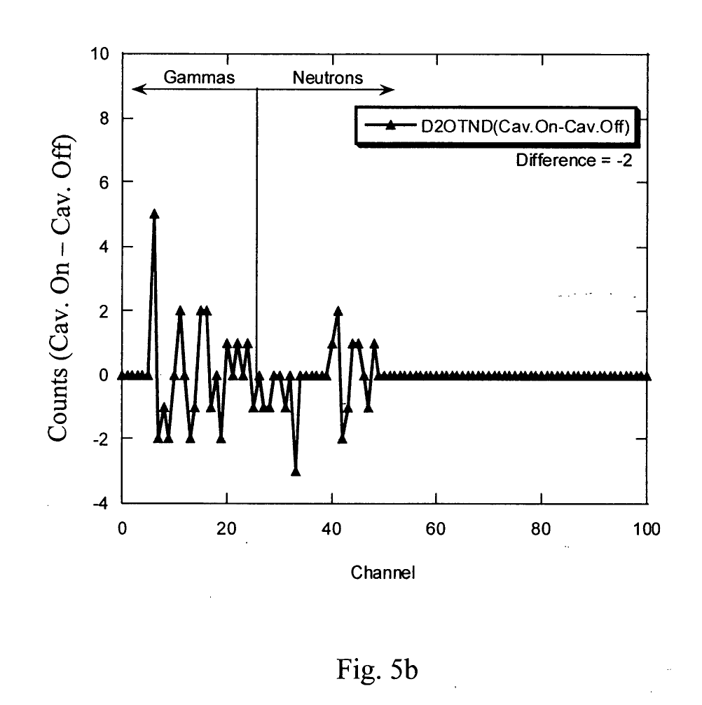

The operations described above were also conducted by dissolving UN in heavy and ordinary water. Results are shown in FIGS. 5a-b and 6. FIG. 5a illustrates neutron-gamma spectra for D₂O with self nucleation and with a BF₃ detector. FIG. 5b illustrates a counts difference spectrum. The data represent a total of ten (10) runs in 5 cycles (each cycle conducted over a span of 300 s first with cavitation on and then for 300 s with cavitation turned off). For these operational parameters there was no statistically significant evidence of nuclear emissions with cavitation, for either H₂O or D₂O.

The data obtained with the Lil thermal neutron nuclear particle detector 310 may be substituted with a BF₃ detector and furthermore, may be complemented with a 5 cm dia×5 cm fluid scintillator (LS) detector 305 for monitoring MeV level neutrons and gamma rays with pulse shape discrimination (PSD) between the neutrons and gamma rays. Raw data from control experiments with C₆H₆—C₂Cl₄—C₃H₆O—UN mixtures and deuterated C₆D₆—C₂Cl₄—C₃D₆O—UN solutions indicate there is a statistically significant (˜17 SD) emission of neutron counts, corresponding to neutron energies of <2.45 MeV.

The neutron track detectors (301-303) may be implemented as CR-39™ neutron track (NT) detectors. The neutron track detectors (301-303) may be used as a passive means for directly confirming and leaving permanent unambiguous evidence for the presence of neutrons. During each experiment three CR-39 NT detectors (301-303) may be placed as shown in FIG. 3. One CR-39 NT detector 303 may be placed approximately 1.5 m away from the test cell to measure the background variations, whereas two neutron track detectors 301 and 302 were affixed to the outside of the glass walls of the test cell. On the aggregate, the production of neutron tracks for the deuterated fluid amounts to a ˜9 SD change indicating a very strong and obvious presence of significant neutron emission with 99.99999% confidence, whereas, for the control fluid the changes were within 0.5 SD indicating no statistically significant change. A confirmatory check was also conducted for cavitation experiments with heavy water (D₂O) where it was found that no significant production of neutron tracks was observed (i.e., the changes were within 1 SD). Overall statistics are summarized in Tables 1 and 2 of FIG. 4. Based on the calibrated efficiency of detection using CR-39 NT detectors a neutron emission rate of ˜5×10³ to ˜10⁴ n/s is estimated, which agrees with the results from other detectors.

Gamma ray spectra may also be obtained using a calibrated gamma ray detector 304, such as a Harshaw™ Nal (5 cm dia×13 cm) detector, to understand better the neutron emission data from the self nucleation experiments. Results for operation with and without cavitation using C₆D₆—C₂Cl₄—C₃D₆O—UN showed a significant increase in gamma ray emissions above background with cavitation on versus off. This was especially noteworthy at ˜1 MeV associated with neutrons captured by chlorine atoms in the test fluid and surrounding materials. Such emissions were not observed for experiments with non-deuterated fluids. These data confirm that neutron emissions during self nucleation are also accompanied with gamma ray emissions due to fusion neutron interactions with surrounding elements. The overall results are given in Table 1 of FIG. 4.

The data in FIGS. 5a-b and 6 and in Table 1 of FIG. 4 are typical of the trends observed when the reactor cell was operating largely without formation of non-spherical streamers or comet-like structures. That is, while huge, statistically significant increases of ˜20 SD could be obtained (FIG. 5b) within a single run of 300 s for the deuterated fluid (i.e., taken over a time span of 300 s with cavitation turned on and then for 300 s with cavitation turned off), the corresponding changes for non-deuterated fluid were well within 1 SD (FIG. 5a) indicating changes were within random variations. The background varied in the course of data acquisition campaigns by about 1 to 2 SD. It is emphasized that several sets of data were obtained alternately over time spans of 100 s and 300 s each with cavitation turned on and cavitation turned off, respectively. Furthermore, for the specific instrument settings and calibrations done during such a campaign a series of runs were conducted for the deuterated and non-deuterated fluid mixtures.

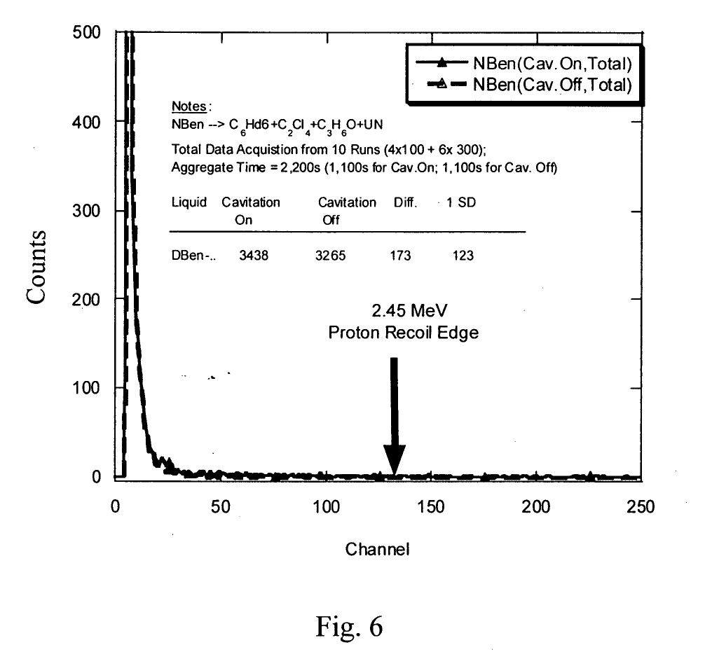

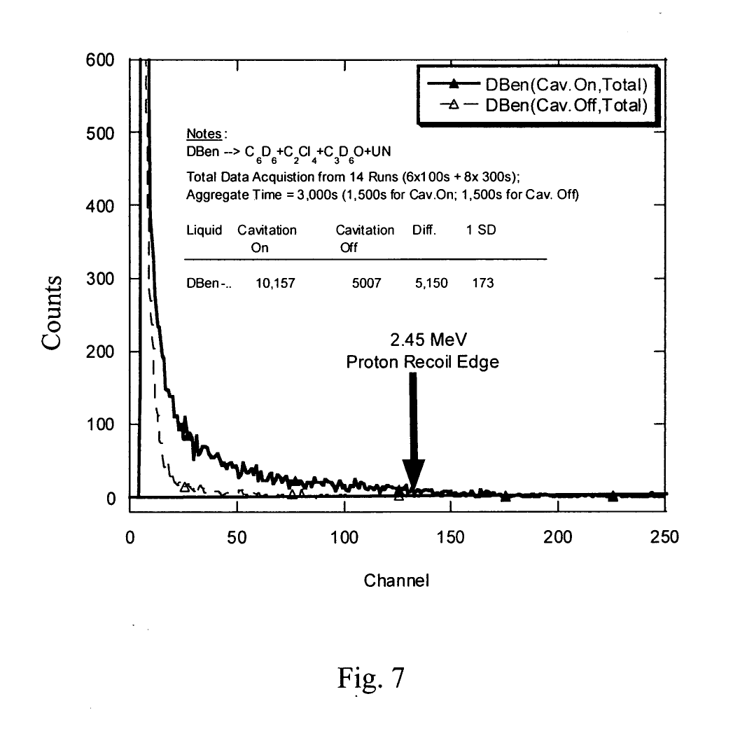

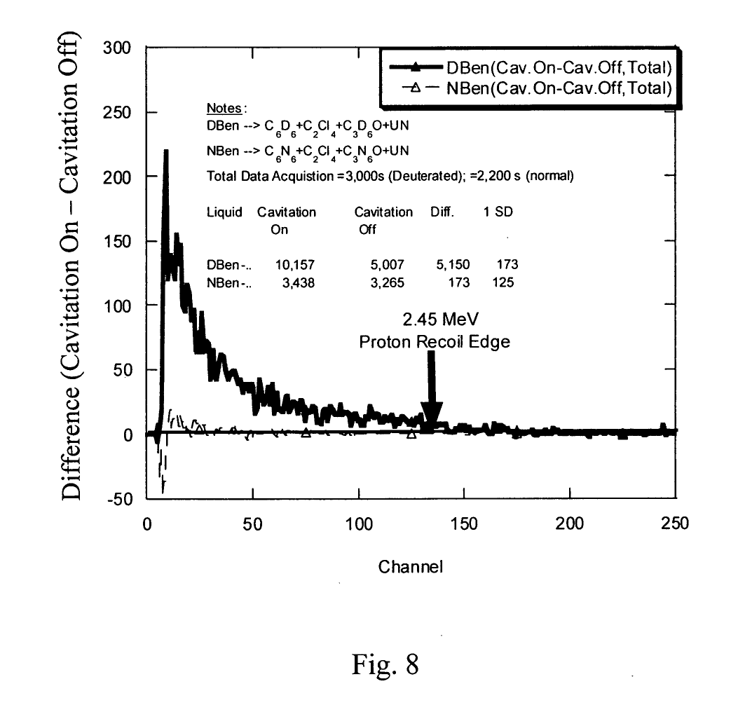

Aggregate results obtained over 3,000 s with the C₆D₆—C₂Cl₄—C₃D₆O—UN mixture, and separately over 2,200 s with the control mixture C₆H₆—C₂Cl₄—C₃H₆O—UN are shown in FIGS. 6 through 8. The results shown in FIG. 6 are composed of 10 runs (i.e.,two sets of runs each taken alternately over a span of 100 s with cavitation on and then for 100 s with cavitation off, plus three sets of runs each taken alternately over a span of 300 s with cavitation on and then for 300 s with cavitation off). The results shown in FIG. 7 are composed of 14 runs (i.e., three sets of runs each taken alternately over a span of 100 s with cavitation on and then for 100 s with cavitation off, plus four sets of runs each taken alternately over a span of 300 s with cavitation on and then for 300 s with cavitation off). There is a ˜30 SD increase of neutron emission for operation with a C₆D₆—C₂Cl₄—C₃D₆O—UN solution, but virtually no change for the control fluid. The maximum neutron energy is seen from FIG. 8 to correspond to <2.45 MeV, indicative of D-D nuclear fusion neutrons.

Gamma ray spectra were also obtained to understand better the neutron emission data from the alpha particle recoil induced nucleation experiments. A Harshaw™ Nal (5 cm diameter×13 cm length) detector mounted on a Canberra 2007P base was utilized for this purpose. Results for operation with and without cavitation using C₆D₆—C₂Cl₄—C₃D₆O—UN showed a noticeable (˜2 SD) increase in gamma ray emissions above background with cavitation on versus off. The 1 MeV region's accumulation of counts may be attributed to gamma emissions when neutrons get absorbed in the chlorine atoms of the test fluid (which has a large cross-section of about 33 barns). Such emissions were not observed for experiments with non-deuterated fluid mixtures. These data confirm that neutron emissions during self nucleation experiments will also be accompanied with limited gamma ray emissions due to neutron interactions with atoms of the test fluid.

A novel, new technique is disclosed to develop a stand-alone acoustic inertial confinement nuclear fusion device. Statistically significant emissions of 2.45 MeV neutrons were measured with multiple independent detectors during self-induced cavitation experiments in deuterated benzene-acetone mixtures, but not in corresponding experiments with nondeuterated control fluids or heavy water. The measured neutron emissions (˜5×10³ to ˜10⁴ n/s) obeyed an inverse square law dependence with distance. These emission rates are acceptably far below break-even levels but clearly represent an obvious evidence for capability to produce significant D-D fusion reactions. Statistically significant gamma ray emissions were also measured during cavitation experiments with chilled C₆D₆—C₂Cl₄—C₃D₆O—UN. As expected, the dissolved emitter did induce cavitation in both D₂O and H₂O, but this did not result in statistically significant changes in the measured neutron counts for either despite far higher bubble cluster nucleation rates. This important result is directly supported by theoretical foundations-based results and underscores the importance of choosing fluids with high (˜1) accommodation coefficients such as acetone and benzene as working liquids versus low (˜0.07) accommodation coefficient inorganic liquids such as water. Notably, simulations from the theory of supercompression indicate the attainability of thermonuclear fusion conditions when using the methodology outlined in this application (i.e., combination of apparatus and organic liquids as described), but not so when the working liquids are inorganic such as water (H₂O or D₂O). This result also draws clear distinction between the present approach and that of conventional systems.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

1. An acoustic inertial confinement reaction device for inducing D-D or D-T reactions comprising:
an enclosure that holds a deuterated fluid wherein the deuterated fluid comprises a plurality of liquids comprising a liquid enabled to dissolve a salt of an alpha emitter and
an acoustic wave energy generator coupled to the enclosure, the acoustic wave energy generator configured to harmonically drive the fluid in the enclosure to induce an acoustic standing wave in the fluid, wherein the alpha emitters nucleate bubble clusters in the fluid as the fluid is driven by the generator, and neutrons, tritium or gamma rays, or a combination thereof being emitted from the fluid.

2. The device of claim 1, wherein the enclosure is configured to be substantially free of neutrons from a neutron source external to the enclosure.

3. The device as in claim 1, wherein the deuterated fluid comprises an organic solvent.

4. The device of claim 1, wherein the plurality of liquids comprises a combination of acetone, C₂Cl₄ and benzene.

5. The device of claim 3, wherein the salt of the alpha emitter comprises at least one of: uranyl nitrate, uranyl acetate, thorium nitrate, and other soluble thorium salt.

6. The device of claim 1, wherein the acoustic wave energy generator comprises a piezoelectric driver coupled to an outside surface of the enclosure.

7. The device of claim 6, wherein the piezoelectric driver comprises a lead-zirconate-titanate (PZT) driver ring.

8. The device of claim 1, wherein the acoustic standing wave comprises a negative pressure antinode of maximum amplitude greater than the threshold pressure for bubble nucleation from uranium or thorium alpha recoils about −5 bar or less.

9. A method of generating radiation from D-D or D-T reactions from an acoustic inertial confinement reaction device comprising:
harmonically or aperiodically driving the fluid in an enclosure to induce an acoustic standing wave in the fluid,
the enclosure holding a deuterated fluid, wherein the deuterated fluid comprises a plurality of liquids comprising a liquid enabled to dissolve a salt of an alpha emitter and a generator coupled to the enclosure,
nucleating bubble clusters in the fluid with the dissolved alpha emitters as the fluid is driven by the generator, thereby generating radiation that is emitted from the fluid.

10. The method of claim 9, wherein generating radiation comprises generating neutrons, tritium, or gamma rays, or a combination thereof.

11. The method of claim 9, wherein the enclosure is configured to be substantially free of neutrons from a neutron source external to the enclosure.

12. The method of claim 9, wherein the deuterated fluid comprises a liquid enabled to dissolve a salt of an alpha emitter and the liquid comprises an organic solvent.

13. The method of claim 12, wherein the plurality of liquids comprises the combination of acetone, C₂Cl₄ and benzene.

14. The method of claim 12, wherein the salt of the alpha emitter comprises at least one of: uranyl nitrate, uranyl acetate, thorium nitrate, and other soluble thorium salt.

15. The method of claim 9, wherein harmonically driving the fluid comprises driving with a piezoelectric driver coupled to an outside surface of the enclosure.

16. The method of claim 15, wherein driving with a piezoelectric driver comprises driving with a lead-zirconate-titanate (PZT) driver ring.

17. The method of claim 9, wherein the acoustic standing wave comprises a pressure antinode of maximum amplitude greater than about 15 bar for alpha-based nucleation.

18. The method of claim 9, wherein the acoustic standing wave comprises a pressure anti node of maximum amplitude greater than about 15 bar for varying D-D reaction output.

19-21. (canceled)

22. The device of claim 3, wherein the salt of the alpha emitter comprises uranyl nitrate.

23. The device of claim 1, wherein said plurality of liquids comprising at least one of: a liquid enabled to lower the vapor pressure of the deuterated fluid; a liquid enabled to increase the average molecular weight of the deuterated fluid; a liquid that enables a lower sonic velocity for the deuterated fluid; and a liquid that is enabled to reduce the magnitude of the negative pressure for nucleation of the deuterated fluid.
